(19) United States
(12) Patent Application Publication
(10) Pub. No.: US 2006/0147760 A1
(43) Pub. Date: Jul. 6, 2006

(54) Perpendicular magnetic recording medium

(75) Inventors: Hiroyuki Uwazumi, Minami-Alps City (JP); Yasushi Sakai, Matsumoto City (JP); Shunji Takenoiri, Matsumoto City (JP); Sadayuki Watanabe, Matsumoto City (JP)

Correspondence Address: ROSSI, KIMMS & McDOWELL LLP., P.O. BOX 826, ASHBURN, VA, 20146-0826, US

(73) Assignee: Fuji Electric Device Technology Co., Ltd., Shinagawa-ku (JP)

(21) Appl. No.: 11/293,875

(22) Filed: Dec. 2, 2005

(30) Foreign Application Priority Data
Dec. 2, 2004 (JP) JP PA 2004-349550

(51) Int. Cl. G11B 5/66

(52) U.S. Cl. 428/831.2; 428/831; 428/829; 428/836.2

(57) ABSTRACT

A perpendicular magnetic recording medium is provided that achieves excellent magnetic performance by suppressing spike noises due to a soft magnetic backing layer, as well as good productivity. The perpendicular magnetic recording medium comprises at least a soft magnetic backing layer, an antiferromagnetic layer, an nonmagnetic underlayer, and a magnetic recording layer sequentially laminated on a nonmagnetic substrate, wherein the magnetic recording layer has a granular structure, the nonmagnetic underlayer is composed of ruthenium or a ruthenium alloy having an hcp structure having a thickness of at least 5 nm, the antiferromagnetic layer is composed of an alloy having an fcc structure and containing at least manganese, and the antiferromagnetic layer is laminated directly on the soft magnetic backing layer. Preferably, the antiferromagnetic layer is composed of an IrMn alloy, and the soft magnetic backing layer has an fcc structure and contains at least nickel and iron. Advantageously, the soft magnetic backing layer consists of two or more directly laminated soft magnetic layers, and a distance between a top surface of the soft magnetic backing layer and a bottom surface of the magnetic recording layer is at most 25 nm.

### CROSS REFERENCE TO RELATED APPLICATIONS

This application is based on, and claims priority to, Japanese Application No. 2004-349550, filed on Dec. 2, 2004, the contents of which are incorporated herein by reference.

### BACKGROUND OF THE INVENTION

A. Field of the Invention

The present invention relates to a perpendicular magnetic recording medium installed in a magnetic recording apparatus, including an external storage device of a computer.

B. Description of the Related Art

In place of conventional longitudinal magnetic recording systems, a perpendicular magnetic recording system is drawing attention as a technology to achieving high density magnetic recording. A double layer perpendicular magnetic recording medium, in particular, is known as a favorable perpendicular magnetic recording medium to achieve high recording density. A double layer perpendicular magnetic recording medium is provided with a soft magnetic film, called a soft magnetic backing layer, under a magnetic recording layer that records information. The soft magnetic backing layer facilitates permeation of magnetic flux generated from a magnetic head and exhibits high saturation magnetic flux density Bs. A double layer perpendicular magnetic recording medium increases the intensity and gradient of the magnetic field generated by the magnetic head, improves recording resolution, and increases leakage flux from the medium.

One of the problems in a perpendicular magnetic recording medium having such a structure is that spike noise, a type of noise generated from a medium, is known to be caused by magnetic domain walls formed in the soft magnetic backing layer. To achieve low noise in a perpendicular magnetic recording medium it is necessary to avoid magnetic domain wall formation in the soft magnetic backing layer.

Some techniques have been proposed to control magnetic domain walls in the soft magnetic backing layer. Japanese Unexamined Patent Application Publication No. H6-180834 proposes a technique in which a ferromagnetic layer of a cobalt alloy or the like is formed on, and/or under, the soft magnetic backing layer, and the ferromagnetic layer is magnetized in a desired orientation. Japanese Unexamined Patent Application Publication No. 2002-352417 proposes a technique in which an antiferromagnetic layer of an IrMn alloy or the like is formed and, utilizing exchange coupling between layers, the magnetization is fixed in one orientation. The latter technique using an antiferromagnetic layer hardly forms a magnetic domain wall even when a magnetic field is applied from outside a storage device. So the latter technique can be regarded as exhibiting superior resistance to the environment as compared to techniques using a ferromagnetic layer.

To ensure proper magnitude of the exchange coupling and suppress the formation of the magnetic domain wall, simple lamination of an antiferromagnetic layer and a soft magnetic backing layer is not effective. Instead, it is necessary that an appropriate seed layer be formed prior to formation of an antiferromagnetic layer to control the crystal alignment and crystallinity of the antiferromagnetic layer. Japanese Unexamined Patent Application Publication No. 2002-352417, for example, discloses that the exchange coupling between the antiferromagnetic layer and the soft magnetic backing layer increases by depositing a tantalum seed layer and an alignment control layer of a NiFe alloy prior to deposition of an antiferromagnetic layer.

Japanese Unexamined Patent Application Publication No. 2002-298326 proposes a perpendicular magnetic recording medium comprising layers sequentially laminated on a nonmagnetic substrate including: a soft magnetic backing layer of a laminate of a thin film of a CoTaZr alloy and a thin film of a NiFe alloy, an antiferromagnetic layer of a manganese alloy such as IrMn, a nonmagnetic underlayer of a TiCr alloy, PdB or the like, a magnetic recording layer of a CoCr-based alloy or a lamination structure of cobalt and platinum or cobalt and palladium, and a protective layer. According to Japanese Unexamined Patent Application Publication No. 2002-298326, good performance can be obtained owing to suppression of spike noises by control of the magnetic domains of the soft magnetic backing layer by the antiferromagnetic layer and owing to control of crystal alignment and crystal grain size of the magnetic recording layer by introducing a nonmagnetic underlayer having a thickness of at most 5 nm.

As described previously, a perpendicular magnetic recording system allows intensity and gradient of the magnetic field generated by a magnetic head to increase by provision of a soft magnetic backing layer. In order to best achieve the effect of the soft magnetic backing layer, however, it is necessary to maintain the distance between the magnetic head and the soft magnetic backing layer as small as possible. In addition, to minimize thicknesses of the protective layer and the magnetic recording layer, the thickness of a nonmagnetic underlayer between the magnetic recording layer and the soft magnetic backing layer is also preferably made as thin as possible.

Japanese Unexamined Patent Application Publication No. 2002-298326, for example, discloses that in a medium comprising a protective layer 5 nm thick, a magnetic recording layer 20 nm thick, and an antiferromagnetic layer 10 nm thick, if a thickness of a nonmagnetic underlayer is 5 nm or more, the recording efficiency lowers and the recording performance degrades in a measurement using a magnetic head of a flying height of 16 nm, and that a thickness of the nonmagnetic underlayer is necessarily at most 5 nm, preferably in a range of 1 to 3 nm. In a conventional magnetic recording layer of a CoCr alloy, the increase in thickness of a nonmagnetic underlayer occasionally swells crystal grain size of a magnetic recording layer associated with the increase of thickness of the nonmagnetic underlayer itself. Thus, an excessively thick nonmagnetic underlayer is unfavorable.

However, study by the present inventors has revealed that a nonmagnetic underlayer having a thickness not larger than 5 nm noticeably degrades the magnetic property and recording performance of the magnetic recording layer, particularly in the case where a heat treatment and a cooling process in a magnetic field are conducted for magnetic domain control. In the magnetic domain control using an antiferromagnetic layer, the substrate needs to be once heated up to a temperature between about 250° C. and 350° C., depending on the material of the antiferromagnetic layer, after depositing at least the antiferromagnetic layer and the soft magnetic backing layer, and cooled down generally applying a magnetic field in the disk radial direction to align orientation of magnetization of the soft magnetic backing layer. The degradation of recording performance can be considered to be due to magnetic interaction between the antiferromagnetic layer and the magnetic recording layer caused by the influence of inter-diffusion of the atoms of the layers that may occur during the heat treatment for magnetic domain control.

For a magnetic recording layer of the perpendicular magnetic recording layer, a so-called granular magnetic recording layer is drawing attention, in which ferromagnetic crystal grains of a cobalt alloy and nonmagnetic and non-metallic grain boundaries of oxide, for example, surround the ferromagnetic crystal grains, as disclosed in Japanese Unexamined Patent Application Publication No. 2003-77122, for example. The granular structure having grain boundaries in the magnetic recording layer composed of oxide or the like can more effectively reduce magnetic interaction between crystal grains than the conventional magnetic recording layer of an alloy of CoCr added with platinum and the like. As a result, the granular structure remarkably reduces the noise generated in the medium and exhibits good recording performance, achieving high density recording.

For noise reduction and thermal stability improvement of the granular magnetic recording layer, appropriate structural control is necessary, including crystal alignment, grain size and its distribution of the ferromagnetic crystal grains, and a width of the grain boundaries of oxide or the like. For this purpose, a plurality of layers including a seed layer and an underlayer are generally formed before forming the magnetic recording layer. Japanese Unexamined Patent Application Publication No. 2003-77122, for example, discloses that the media noise can be reduced by depositing a seed layer of an amorphous structure, an alignment control layer of a NiFe alloy or the like, and an underlayer of ruthenium or the like before depositing the granular magnetic recording layer. The reference further discloses that a thickness of the underlayer of ruthenium or the like is necessarily at least 3 nm, preferably at least 5 nm for the structural control of the magnetic recording layer.

An excellent perpendicular magnetic recording medium can be formed having a soft magnetic backing layer that generates no spike noise and a granular magnetic recording layer that exhibits low noise and high thermal stability by combining the above-mentioned prior arts, specifically the magnetic domain control technique for a soft magnetic backing layer disclosed in Japanese Unexamined Patent Application Publication No. 2002-352417 and the granular magnetic recording layer and the layer structure for structural control of the recording layer disclosed in Japanese Unexamined Patent Application Publication No. 2003-77122. However, a medium produced by adopting all these layer structures should have at least nine different layers sequentially laminated on nonmagnetic substrate 1, as shown in FIG. 3. The nine layers are seed layer 8, first alignment control layer 9, antiferromagnetic layer 3, soft magnetic backing layer 2, second alignment control layer 10, nonmagnetic underlayer 4, granular magnetic recording layer 5, protective layer 6, and lubricant layer 7. Lamination of this many layers requires a complex and expensive deposition apparatus and raises production costs of the medium. The lamination of multiple layers makes the control of thicknesses and magnetic properties very complicated, which is also a problem raised by the prior arts.

The present invention is directed to overcoming or at least reducing the effects of one or more of the problems set forth above.

### SUMMARY OF THE INVENTION

In view of the above problems, an object of the present invention is to provide a perpendicular magnetic recording medium exhibiting excellent magnetic recording performance by suppressing spike noises caused by a soft magnetic backing layer. Another object of the invention is to provide a perpendicular magnetic recording medium exhibiting good productivity.

A perpendicular magnetic recording medium according to the present invention comprises at least a soft magnetic backing layer, an antiferromagnetic layer, a nonmagnetic underlayer, and a magnetic recording layer sequentially laminated on a nonmagnetic substrate in this order. The nonmagnetic underlayer is composed of ruthenium or a ruthenium alloy having a hexagonal closed packed structure (hcp) and a thickness of at least 5 nm. The magnetic recording layer is composed of ferromagnetic crystal grains mainly consisting of a ferromagnetic CoPt alloy and nonmagnetic grain boundaries mainly consisting of oxide surrounding the crystal grains. The antiferromagnetic layer is composed of an alloy containing at least manganese and having a face centered cubic structure (fcc). The antiferromagnetic layer is laminated directly on the soft magnetic backing layer. Advantageously, the antiferromagnetic layer is composed of an IrMn alloy.

Preferably, the soft magnetic backing layer has a face centered cubic crystal structure and is composed of an alloy containing at least nickel and iron, and has a structure consisting of two or more directly laminated soft magnetic layers. A first soft magnetic backing layer that is in contact with the antiferromagnetic layer has a face centered cubic lattice structure and is composed of an alloy containing at least nickel and iron. A second soft magnetic backing layer that is disposed between the nonmagnetic substrate and the first soft magnetic backing layer has an amorphous structure and contains at least cobalt.

A distance between a top surface of the soft magnetic backing layer and a bottom surface of the magnetic recording layer is preferably at most 25 nm.

The present invention makes it possible to form an excellent perpendicular magnetic recording medium having a soft magnetic backing layer that generates no spike noise and a granular magnetic recording layer that exhibits low noise and high thermal stability, employing a remarkably simplified layer structure as compared with a currently required layer structure. Because a deposition apparatus for fabricating the layers is simple and inexpensive, the production cost of the medium is reduced. Thicknesses and magnetic properties of the layers can be controlled simply.

A nonmagnetic underlayer of ruthenium or a ruthenium alloy with a thickness not smaller than 5 nm can favorably control the structure of the granular magnetic recording layer, and intercepts the magnetic interaction between the antiferromagnetic layer and the magnetic recording layer, even when a heat treatment is conducted for magnetic domain control. Thus, desirable recording is realized.

A lamination structure of an antiferromagnetic layer of a manganese alloy and a nonmagnetic underlayer of ruthenium or a ruthenium alloy can control the microstructure of the granular magnetic recording layer more effectively without increasing a total film thickness than a conventional single nonmagnetic underlayer of ruthenium or a ruthenium alloy. That is, the largest effect of the soft magnetic backing layer can be obtained without increasing the thickness of the nonmagnetic layers existing between the soft magnetic backing layer and the magnetic recording layer from the conventional thickness.

Since ruthenium is more expensive than IrMn, thickness reduction of the nonmagnetic underlayer of ruthenium or a ruthenium alloy in the invention means that the production cost of the lamination of IrMn and ruthenium in the layer structure of the invention is lower than the production cost of a conventional single ruthenium layer.

Some aspects of preferred embodiments of the invention will be described below with reference to the accompanying drawings.

### BRIEF DESCRIPTION OF THE DRAWINGS

The foregoing advantages and features of the invention will become apparent upon reference to the following detailed description and the accompanying drawings, of which:

FIG. 1 is a schematic sectional view illustrating a structure of a perpendicular magnetic recording medium of a first embodiment example according to the invention;

FIG. 2 is a schematic sectional view illustrating a structure of a perpendicular magnetic recording medium of a second embodiment example according to the invention;

FIG. 3 is a schematic sectional view illustrating a structure of a perpendicular magnetic recording medium of an example according to a prior art;

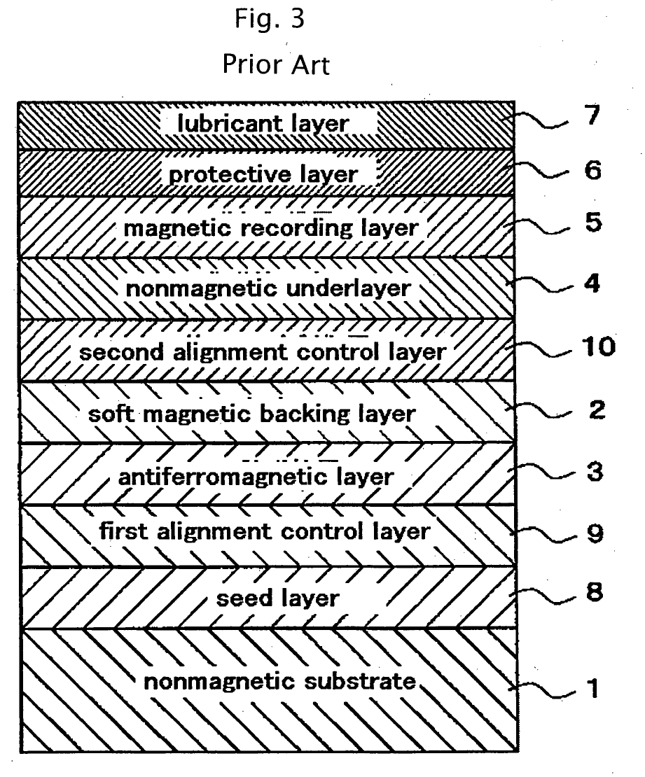

FIG. 4 is a graph illustrating dependence of the exchange coupling magnetic field Hex on the thickness of an IrMn antiferromagnetic film in the perpendicular magnetic recording medium of Example 1; and

FIG. 5 is a graph illustrating dependence of the signal-to-noise ratio (SNR) on the thickness of a ruthenium nonmagnetic underlayer film in the perpendicular magnetic recording media of Examples 2 and 3 and Comparative Examples 1 and 2.

### DETAILED DESCRIPTION OF SPECIFIC EMBODIMENTS

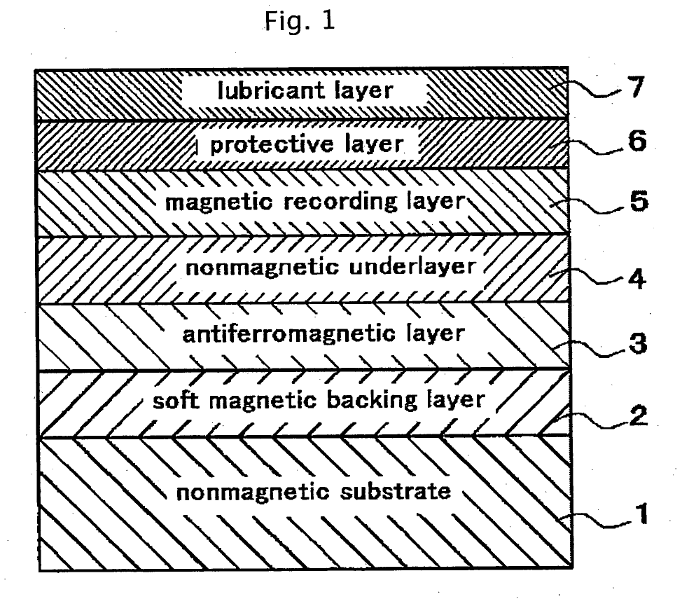

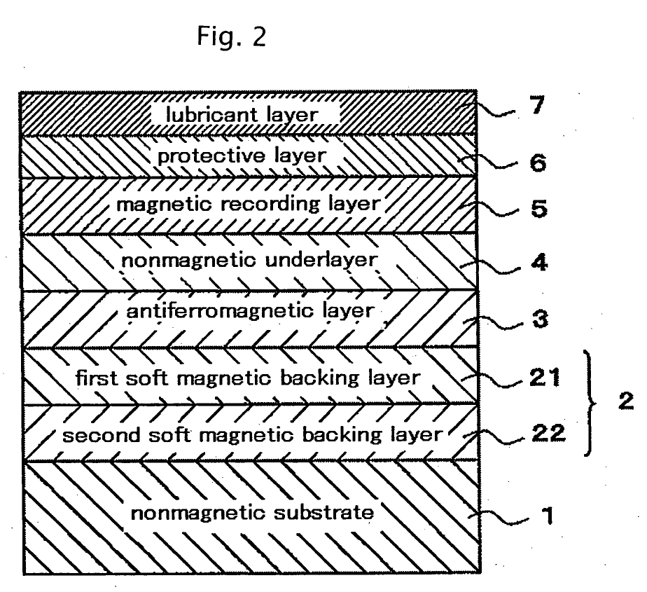

FIG. 1 shows a first example of a structure of a perpendicular magnetic recording medium according to the invention. A perpendicular magnetic recording medium of the invention comprises soft magnetic backing layer 2, antiferromagnetic layer 3, nonmagnetic underlayer 4, magnetic recording layer 5, and protective layer 6 laminated on nonmagnetic substrate 1 in this order. On protective layer 6, lubricant layer 7 is formed. FIG. 2 shows a second example of a perpendicular magnetic recording medium according to the invention, in which soft magnetic baking layer 2 consists of two layers. On nonmagnetic substrate 1 formed are second soft magnetic backing layer 22, first soft magnetic backing layer 21, antiferromagnetic layer 3, nonmagnetic underlayer 4, magnetic recording layer 5, and protective layer 6, in this order. Lubricant layer 7 is formed on protective layer 6.

Nonmagnetic substrate 1 can be selected from the substrates commonly used in a magnetic recording media including a Ni—P plated aluminum alloy substrate, a glass substrate of chemically strengthened glass or crystallized glass, a silicon substrate, and other smooth substrates.

Magnetic recording layer 5 is a so-called granular magnetic recording layer consisting of ferromagnetic crystal grains and nonmagnetic grain boundaries mainly composed of nonmagnetic metal oxide surrounding the crystal grains. Magnetic recording layer 5 having such a structure can be fabricated by deposition either by means of a sputtering method using a ferromagnetic metal target that contains the oxide composing the nonmagnetic grain boundary or by means of a reactive sputtering method using a ferromagnetic metal target that is carried out in an argon gas atmosphere containing oxygen.

A CoPt-based alloy is preferably used for a material composing the ferromagnetic grains. Other ferromagnetic materials can be used also, without any special limitation. The CoPt-based alloy preferably contains at least one element selected from Cr, Ni, Ta, and B for reduction of magnetic recording media noise. A material for composing the nonmagnetic grain boundary can be an oxide(s) of at least one element selected from Cr, Co, Si, Al, Ti, Ta, Hf, and Zr. These materials allow a stable granular structure to form. The thickness of magnetic recording layer 5 is appropriately determined according to the desired magnetic properties and is required to be a thickness that attains sufficient read-head output and read-write resolution in a read-write process.

A thin film mainly consisting of carbon, for example, can be used for protective layer 6. The carbon protective layer can be fabricated by means of sputtering method or a chemical vapor deposition (CVD) method. A liquid lubricant of perfluoropolyether, for example, can be used for lubricant layer 7.

Nonmagnetic underlayer 4 is composed of ruthenium or a ruthenium alloy having an hcp crystal structure. A thickness of the underlayer is at least 5 nm. To appropriately control microscopic structure of magnetic recording layer 5 having a granular structure, magnetic recording layer 5 is laminated directly on nonmagnetic underlayer 4 of ruthenium or a ruthenium alloy.

A thickness of the nonmagnetic underlayer less than 5 nm can not provide appropriate structural control of the granular magnetic recording layer and fails to achieve desired magnetic properties and recording characteristics. When the magnetic recording layer does not have a granular structure, but is composed of a conventional Co—Cr-based alloy, even a very thin nonmagnetic underlayer having a thickness of 1 to 5 nm can often provide desirable structural control of the magnetic layer, which means principally minimization of crystal grains and control of crystal alignment. On the other hand, an increase in thickness of the nonmagnetic underlayer may increase the crystal grains in the magnetic recording layer that is associated with an increase of crystal grains in the nonmagnetic underlayer itself. Therefore, a nonmagnetic underlayer that is too thick is undesirable.

In structure control of a granular magnetic recording layer containing oxide, the nonmagnetic underlayer plays a role to promote precipitation of the oxide to the grain boundary in addition to minimizing crystal grains and control of crystal alignment. In that case, according to the studies by the inventors, the most favorable material for the nonmagnetic underlayer is ruthenium or a ruthenium alloy and the thickness is necessarily at least 5 nm. The grain size of the granular magnetic recording layer is little affected by the increase of underlayer thickness owing to the presence of the oxide. So, the thickness of the nonmagnetic underlayer can be increased as compared with a magnetic recording layer of CoCr-based alloy, although a certain upper limit exists as described later.

Further, if the nonmagnetic underlayer is a thin film having a thickness less than 5 nm in a perpendicular magnetic recording medium of the invention, it is affected by inter-diffusion of atoms that presumably occurs during heat treatment for magnetic domain control. The magnetic interaction may occur between the antiferromagnetic layer and the magnetic recording layer, to degrade recording characteristics.

Antiferromagnetic layer 3 is composed of an alloy containing at least manganese having an fcc structure. To give high exchange anisotropy to the soft magnetic backing layer 2, an IrMn alloy containing iridium in a range of 10 to 30 at % is particularly favorable. It is necessary that the soft magnetic backing layer and the antiferromagnetic layer be directly laminated, which means that the soft magnetic backing layer and the antiferromagnetic layer are in a direct exchange coupling condition. It is necessary for the suppression of spike noises that the magnetization curve of the soft magnetic backing layer be shifted in one direction, because the exchange anisotropy from the antiferromagnetic layer and the soft magnetic layer has a single magnetic domain free of a domain wall. To increase the effect of suppressing spike noises, antiferromagnetic layer 3 preferably has a thickness of at least 4 nm.

As one possible method of obtaining a single magnetic domain, all layer structures up to the protective layer 6 are deposited in a vacuum chamber used for deposition processes, and then the substrate having the layer structures is once heated to a temperature higher than a blocking temperature at which the exchange coupling between antiferromagnetic layer 3 and soft magnetic backing layer 2 disappears. The blocking temperature is generally in the range of 250° C. to 350° C. By subsequently cooling in a homogeneous magnetic field of about 100 Oe parallel to the deposition surface of the nonmagnetic substrate, the magnetization aligns in the applied magnetic field, and thus a single magnetic domain state free of a domain wall is obtained. In the case of disk shape nonmagnetic substrate, the magnetic field is preferably applied in the radial direction.

Soft magnetic backing layer 2 preferably has an fcc structure and is an alloy containing at least nickel and iron in order to favorably control alignment and crystallinity of antiferromagnetic layer 3 that is laminated on soft magnetic backing layer 2 and to obtain strong exchange anisotropy. A soft magnetic backing layer with this feature favorably controls the structure of the nonmagnetic underlayer through structural control of the antiferromagnetic layer and provides a desired microstructure of the granular magnetic recording layer.

Crystal alignment planes parallel to the film surface are preferably an fcc (111) plane in soft magnetic backing layer 2, an fcc (111) plane in antiferromagnetic layer 3, an hcp (002) plane in the nonmagnetic underlayer, and an hcp (002) plane in the magnetic recording layer. This structure allows all the layers to continuously grow epitaxially, which eventually improves crystal alignment of the magnetic recording layer.

In the second structural example according to the invention shown in FIG. 2, the soft magnetic backing layer consists of two laminated layers: first soft magnetic backing layer 21 in contact with antiferromagnetic layer 3 and second soft magnetic backing layer 22 disposed between first soft magnetic backing layer 21 and nonmagnetic substrate 1. Advantageously, first soft magnetic backing layer 21 is composed of an alloy having an fcc structure and containing at least nickel and iron and second soft magnetic backing layer 22 is composed of an alloy having an amorphous structure and containing at least cobalt. First soft magnetic backing layer 21 and second soft magnetic backing layer 22 need to be directly laminated so that magnetization of the two layers behaves almost like a monolithic body in response to an applied magnetic field. Under this condition, an exchange coupling develops between soft magnetic backing layer 2 consisting of the two layers and antiferromagnetic layer 3 as described above, and the magnetization of soft magnetic backing layer 2 receives exchange anisotropy from antiferromagnetic layer 3. To suppress spike noises, it is necessary that the magnetization curve shifts in one direction and that soft magnetic backing layer 2 becomes a single magnetic domain free of a domain wall.

In the second structural example, second soft magnetic backing layer 22 functions as a seed layer for improving crystal alignment and crystallinity of first soft magnetic backing layer 21, providing an excellent perpendicular magnetic recording medium.

An alignment control layer composed of tantalum, for example, can be further provided between nonmagnetic underlayer 4 and antiferromagnetic layer 3. Here, to maximize the effect of the soft magnetic backing layer, the distance between the top surface of the soft magnetic backing layer and the bottom surface of the magnetic recording layer, that is the sum of thicknesses of the nonmagnetic underlayer, the antiferromagnetic layer, and the above-mentioned alignment control layer, is preferably at most 25 nm, more preferably at most 20 nm. Additional soft magnetic or nonmagnetic layers may be provided between soft magnetic backing layer 2 and nonmagnetic substrate 1.

A perpendicular magnetic recording medium having this layer structure according to the invention has a layer structure consisting of six layers in the minimum case, which is a very simplified layer structure as compared with a conventional perpendicular magnetic recording medium that needs at least nine layers. Moreover, the perpendicular magnetic recording medium of the invention exhibits excellent recording performance.

Some specific embodiment examples of the perpendicular magnetic recording medium according to the invention will be described in the following.

### EXAMPLE 1

The nonmagnetic substrate used was a strengthened glass substrate with a disk shape having a nominal diameter of 2.5 inches (N-5 manufactured by HOYA Corporation). After cleaning, the substrate was introduced into a sputtering apparatus. Soft magnetic backing layer 2 having a thickness of 150 nm was formed of a NiFe alloy having an fcc structure under an argon gas pressure of 5 mTorr using a target of a Ni22Fe alloy. (The numeral represents atomic percent of the following element, namely, 22 at % of Fe and the remainder of Ni. The same notation applies in the following descriptions.) Subsequently, antiferromagnetic layer 3 was formed of an IrMn alloy having an fcc structure under an argon gas pressure of 20 mTorr using a target of Ir80Mn alloy. The thicknesses of the antiferromagnetic layers were varied in the range of zero to 10 nm. Subsequently, nonmagnetic underlayer 4 having a thickness of 10 nm was formed of ruthenium having an hcp structure under an argon gas pressure of 30 mTorr using a target of ruthenium. Then, granular magnetic recording layer 5 having a thickness of 15 nm was formed by means of an RF sputtering method under an argon gas pressure of 10 mTorr using a target containing SiO₂ of 90 mol % (Co10Cr12Pt)-10 mol % (SiO₂). Then, carbon protective layer 6 having a thickness of 5 nm was laminated. Subsequently, the substrate having the layers up to the protective layer was heated to 250° C. by a lamp heater in the vacuum chamber of the sputtering apparatus. Immediately after that, the substrate was left within a magnetic circuit with a permanent magnet that can apply a magnetic field of 120 Oe in the disk radial direction. After the substrate temperature was dropped below 100° C., the substrate was taken out of the vacuum chamber, and a liquid lubricant was applied to a thickness of 1.5 nm. Thus, perpendicular magnetic recording media having a structure shown in FIG. 1 were manufactured.

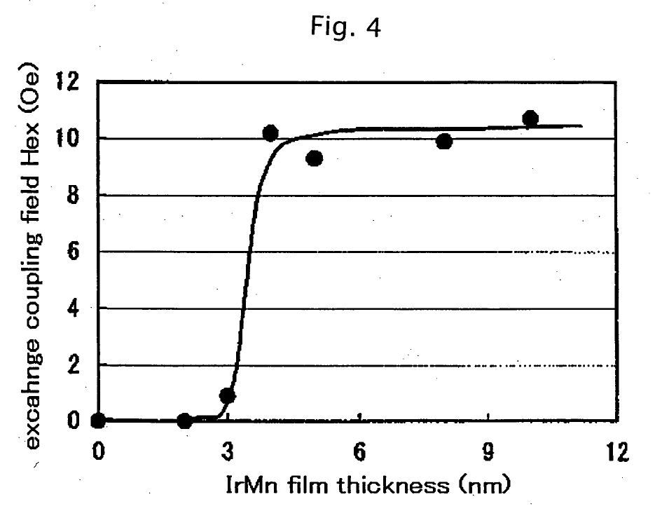

The manufactured perpendicular magnetic recording medium was cut into pieces of 8 mm square and the magnetization curve was measured using a vibration sample magnetometer (VSM) applying a magnetic field with a maximum applied magnetic field of 1 kOe in a direction in the sample plane and in a radial direction of the disk before cutting. FIG. 4 shows dependence of the obtained loop shift of the magnetization curve, that is, the exchange coupling field Hₑₓ, on the thickness of the IrMn film. The Hₑₓ is an index of strength of the exchange coupling between the soft magnetic backing layer and the antiferromagnetic layer.

While the measured Hₑₓ value was nearly zero for an IrMn film thickness of up to 3 nm, the Hₑₓ value of about 10 Oe was obtained for an IrMn film thickness in the range of 4 nm to 10 nm.

Then, a read-write characteristic was measured using a spin-stand tester equipped with single magnetic pole head for perpendicular magnetic recording (track width of 0.2 μm and flying height of 10 nm). First, direct current demagnetization was conducted on the whole surface of the disc with a write current of 50 mA. Then, reproduction of signals was conducted over the whole surface of the disk to measure spike noises. Table 1 shows generation of spike noises in the perpendicular magnetic recording media of Example 1 with various thicknesses of the IrMn film. In accordance to the results of FIG. 4, spike noise was prevented for the thickness of the IrMn film at 4 nm or more, in which high Hₑₓ value was obtained. In contrast, spike noises were generated in the media without an IrMn film or the media having an IrMn film thickness of 3 nm or thinner, in which sufficiently high Hₑₓ was not obtained. Thus, it has been demonstrated that an IrMn film having a thickness of 4 nm or more provides a perpendicular magnetic recording medium that prevents generation of spike noises.

TABLE 1

| IrMn film thickness (nm) | generation of spike noises |
|---|---|
| 0 | frequently generated |
| 2 | frequently generated |
| 3 | frequently generated |
| 4 | not generated |
| 5 | not generated |
| 8 | not generated |
| 10 | not generated |

### EXAMPLE 2

Perpendicular magnetic recording media having a structure of FIG. 1 were manufactured in the same manner as in Example 1 except that the thickness of the antiferromagnetic layer was fixed to 5 nm and the thickness of the nonmagnetic underlayer was varied in the range of zero to 25 nm.

### EXAMPLE 3

Perpendicular magnetic recording media having a structure of FIG. 2 were manufactured in the same manner as in Example 2 except that after cleaned nonmagnetic substrate was introduced into a sputtering apparatus, second soft magnetic backing layer 22 having a thickness of 120 nm was formed of a CoZrNb alloy having an amorphous structure under an argon gas pressure of 5 mTorr using a target of Co5Zr5Nb and subsequently first soft magnetic backing layer 21 having a thickness of 30 nm was formed of a NiFe alloy.

### COMPARATIVE EXAMPLE 1

Perpendicular magnetic recording media for comparison were manufactured in the same manner as in Example 2 except that an antiferromagnetic layer was not provided.

### COMPARATIVE EXAMPLE 2

Perpendicular magnetic recording media for comparison were manufactured in the same manner as in Example 2 except that the substrate after deposition of a nonmagnetic underlayer was heated up to 250° C. in the vacuum chamber by the lamp heater and then a magnetic recording layer 15 nm thick was formed of a CoCrPt alloy by means of a DC sputtering method under an argon gas pressure of 10 mTorr using a target of Co20Cr10Pt.

On these media, read-write characteristics were measured using a spinning stand tester equipped with single magnetic pole head for perpendicular magnetic recording (track width of 0.2 μm and flying height of 10 nm). First, direct current demagnetization was conducted on the whole surface of the disc with a write current of 50 mA. Then, reproduction of signals was conducted over the whole surface of the disk to measure spike noises. No spike noise was detected in all of the perpendicular magnetic recording media of Example 2 and Example 3, while spike noises were detected in all of the perpendicular magnetic recording media of Comparative Example 1.

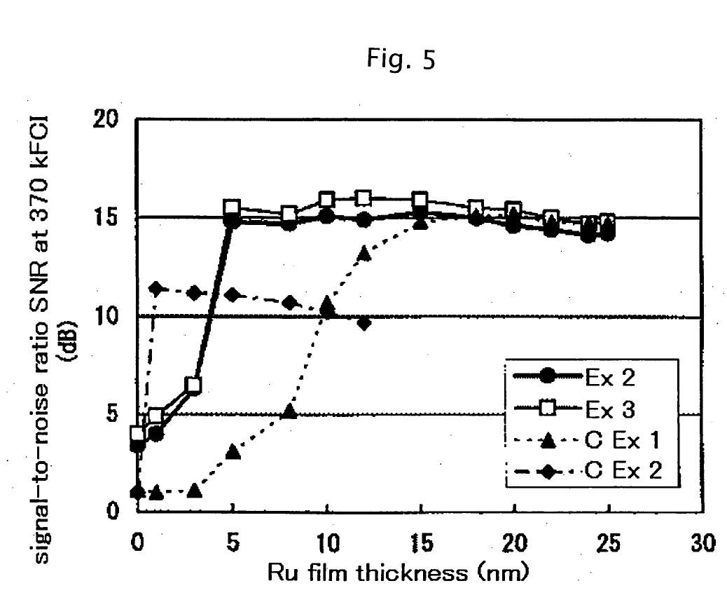

Then, signal-to-noise ratio (SNR) was measured on these media at a recording density of 370 kFCl (flux change per inch). FIG. 5 shows the dependence of SNR on a ruthenium film thickness of the media.

In the perpendicular magnetic recording media of Example 2, the SNR increases with increase of the ruthenium film thickness and reaches 15 dB at a ruthenium film thickness of 5 nm. The SNR degrades slightly in the range of the ruthenium film thickness more than 15 nm, which is a region of the sum of the film thicknesses of the ruthenium film and the IrMn antiferromagnetic film of more than 20 nm. Further degradation of SNR occurs for the ruthenium film thickness more than 20 nm. The degradation of SNR in the very thick ruthenium film is presumably caused by increase of the distance between the soft magnetic backing layer and the magnetic head.

The SNR in the perpendicular magnetic recording media of Example 3 shows similar dependence on the ruthenium film thickness to those of the perpendicular magnetic recording media of Example 2, while the values of SNR in Example 3 are higher by 0.5 to 1.0 dB than those in Example 2. This can be resulted from the double layered structure of the soft magnetic backing layer, in which the second soft magnetic layer of a CoZrNb alloy formed beneath the first soft magnetic layer of a NiFe alloy worked as a seed layer to favorably change the microstructure of the magnetic recording layer.

The perpendicular magnetic recording medium of Comparative Example 1 exhibited very low SNR values of less than 10 dB for thicknesses of the ruthenium film less of than 10 nm. The SNR increases with increase of the ruthenium film thickness and reaches about 15 dB in the region of the ruthenium film thickness of from 15 nm to 25 nm. The SNR value around 15 dB is equivalent to those in Example 1 with the ruthenium film thickness of from 10 nm to 20 nm. This means that, in the perpendicular magnetic recording media of Example 1, the SNR value equivalent to that in Comparative Example 1 can be obtained with a thinner ruthenium film.

The perpendicular magnetic recording media of Comparative Example 2 exhibits an SNR value of about 11 dB even with a very thin ruthenium film of 1 nm. Thus, Comparative Example 2 using a CoCr alloy without a granular structure for a magnetic recording layer can exhibit a relatively high SNR value in a very thin ruthenium film of 1 nm. However, the SNR value is lower by a significant value of 4 dB than the SNR values in Examples 2 and 3 that comprise a magnetic recording layer having a granular structure.

With the ruthenium film thicknesses of 3 nm and thicker, the SNR gradually decreases, which can be attributed principally to increase of the grain size in the magnetic recording layer associated with increase of the ruthenium film thickness.

Thus, a perpendicular magnetic recording medium has been described according to the present invention. Many modifications and variations may be made to the techniques and structures described and illustrated herein without departing from the spirit and scope of the invention. Accordingly, it should be understood that the devices and methods described herein are illustrative only and are not limiting upon the scope of the invention.

What is claimed is:

1. A perpendicular magnetic recording medium comprising:
a soft magnetic backing layer,
an antiferromagnetic layer comprising an alloy containing at least manganese and having a face centered cubic structure (fcc),
a nonmagnetic underlayer comprising ruthenium or a ruthenium alloy having a hexagonal closed packed structure (hcp) and a thickness of at least 5 nm, and
a magnetic recording layer comprising ferromagnetic crystal grains of a ferromagnetic CoPt alloy and nonmagnetic grain boundaries of oxide surrounding the crystal grains,
wherein said layers are sequentially laminated on a nonmagnetic substrate and the antiferromagnetic layer is laminated directly on the soft magnetic backing layer.

2. The perpendicular magnetic recording medium according to claim 1, wherein the antiferromagnetic layer is composed of an IrMn alloy.

3. The perpendicular magnetic recording medium according to claim 1, wherein the soft magnetic backing layer has a face centered cubic structure and is composed of an alloy containing at least nickel and iron.

4. The perpendicular magnetic recording medium according to claim 2, wherein the soft magnetic backing layer has a face centered cubic structure and is composed of an alloy containing at least nickel and iron.

5. The perpendicular magnetic recording medium according to claim 1, wherein the soft magnetic backing layer has a structure consisting of two or more directly laminated soft magnetic layers in which a first soft magnetic backing layer that is in contact with the antiferromagnetic layer has a face centered cubic lattice structure and is composed of an alloy containing at least nickel and iron, and a second soft magnetic backing layer that is disposed between the nonmagnetic substrate and the first soft magnetic backing layer has an amorphous structure and contains at least cobalt.

6. The perpendicular magnetic recording medium according to claim 2, wherein the soft magnetic backing layer has a structure consisting of two or more directly laminated soft magnetic layers in which a first soft magnetic backing layer that is in contact with the antiferromagnetic layer has a face centered cubic lattice structure and is composed of an alloy containing at least nickel and iron, and a second soft magnetic backing layer that is disposed between the nonmagnetic substrate and the first soft magnetic backing layer has an amorphous structure and contains at least cobalt.

7. The perpendicular magnetic recording medium according to claim 1, wherein a distance between a top surface of the soft magnetic backing layer and a bottom surface of the magnetic recording layer is at most 25 nm.

8. The perpendicular magnetic recording medium according to claim 2, wherein a distance between a top surface of the soft magnetic backing layer and a bottom surface of the magnetic recording layer is at most 25 nm.

9. The perpendicular magnetic recording medium according to claim 4, wherein a distance between a top surface of the soft magnetic backing layer and a bottom surface of the magnetic recording layer is at most 25 nm.

10. The perpendicular magnetic recording medium according to claim 6, wherein a distance between a top surface of the soft magnetic backing layer and a bottom surface of the magnetic recording layer is at most 25 nm.
